(19) United States
(12) Patent Application Publication
(10) Pub. No.: US 2006/0261780 A1
(43) Pub. Date: Nov. 23, 2006

(54) System and method for information handling system battery monitoring

(76) Inventors: Larry G. Edington, Mountain Home, AR (US); Muhammed K. Jaber, Austin, TX (US)

Correspondence Address: HAMILTON & TERRILE, LLP, P.O. BOX 203518, AUSTIN, TX, 78720, US

(21) Appl. No.: 11/134,931

(22) Filed: May 23, 2005

(51) Int. Cl. H02J 7/00

(52) U.S. Cl. 320/130

(57) ABSTRACT

Information handling system battery monitoring tracks battery usage for warranty coverage. A timer state machine running on the battery tracks time expired from initiation of a warranty period, such as the first non-manufacture boot of the information handling system or detection of a new battery interfaced with the information handling system. The expired warranty period and a unique identifier stored on the battery are communicated by a battery manager running on the information handling system to battery warranty site. The manufacturer of the information handling system applies the expired warranty period and unique identifier to determine warranty coverage for the battery.

### BACKGROUND OF THE INVENTION

1. Field of the Invention

The present invention relates in general to the field of information handling system batteries, and more particularly to a system and method for information handling system battery monitoring.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems have grown more powerful, the power consumed by information handling systems has tended to increase. This has presented a difficulty with portable information handling systems that are designed to run on internal power. Batteries with inadequate storage do not support information handling system operations on internal power for sufficient time. Thus, as the processing capabilities of information handling systems have increased, batteries with greater power storage have been needed to maintain the same internal power operating times. At the same time, users have continued to demand that portable information handling systems have minimal size and weight. As a result, the cost of information handling system batteries has steadily increased. Further, a rundown battery having reduced power storage capacity is often more noticeable to a user since the operating time on internal power tends to drop off rapidly.

Information handling system internal batteries are typically designed to maintain their power storage capacity for over a year. Generally, information handling system manufacturers will warrant a battery for a year from purchase or for a certain number of charge cycles. The number of charge cycles is tracked with a microcontroller integrated in the battery, which controls battery operations. As batteries have increased in cost, users have had a greater incentive to call on the warranty just before the end of the warranty period to obtain a replacement battery with another year of life. In some instances, users have called on the warranty and, instead of returning the battery actually under warranty, have kept the battery under warranty and sent in an older failed battery. The resulting increase in warranty costs from such false claims tends to increase overall manufacturing costs and are, in effect, borne by other information handling system purchasers. However, manufacturers have difficulty tracking battery failures and tend to give users the benefit of doubt when a warranty claim is made.

### SUMMARY OF THE INVENTION

Therefore a need has arisen for a system and method which effectively tracks information handling system battery use for warranty purposes.

In accordance with the present invention, a system and method are provided which substantially reduce the disadvantages and problems associated with previous methods and systems for tracking information handling system battery use. A timer integrated in an information handling system battery tracks time expired from a warranty period for the battery to confirm warranty coverage in the event of a failure of the battery.

More specifically, at manufacture of an information handling system, a battery unique identifier and warranty terms are stored for the information handling system in a battery warranty database. Upon the first non-manufacture start, such as the first start by a user after delivery of the information handling system, a battery manager on the information handling system initiates a timer state machine of the battery to track usage under warranty. A user request for warranty coverage of the battery results in the battery manager retrieving the expired time and the unique identifier from the battery and sending the information to a battery warranty site for confirmation of battery warranty coverage. A prorata engine determines the warranty coverage remaining and a verification engine verifies that the unique identifier matches that of a battery in the battery warranty database that is covered by warranty. When the user exchanges the failed battery, the verification engine reads the expired time and unique identifier from the returned battery to verify that the user returned the correct battery.

The present invention provides a number of important technical advantages. One example of an important technical advantage is that time expired from an information handling system battery warranty is tracked at the battery to aid accurate warranty coverage. The risk of fraudulent warranty claims is reduced by pro rata refunds for defective batteries with the amount of the refund based on the expired time kept by the battery timer state machine. Verification of a battery as covered by a warranty by reference to the battery unique identifier ensures that the correct battery is returned instead of different defective battery. The time state machine is enabled with a microcontroller and firmware commonly used on batteries for other functions so that relatively inexpensive firmware modifications to existing batteries will support battery warranty monitoring.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for monitoring information handling system battery warranties;

FIG. 2 depicts a block diagram of an information handling system having battery warranty monitoring; and

FIG. 3 depicts a method for monitoring an information handling system battery warranty.

### DETAILED DESCRIPTION

A timer running on an information handling system battery tracks battery usage for a determination of warranty expiration. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

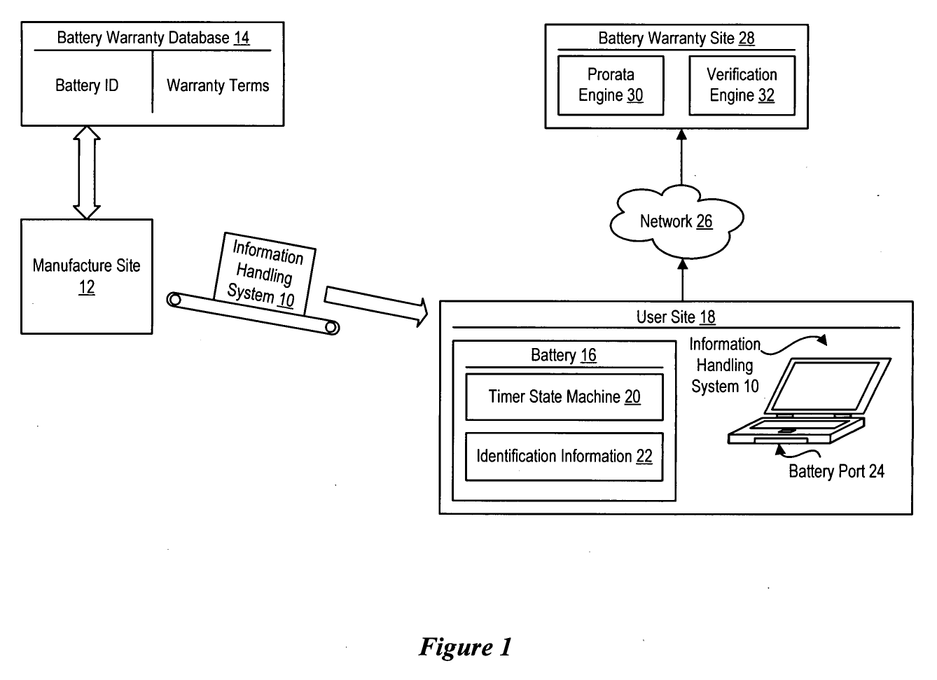

Referring now to FIG. 1, a block diagram depicts a system for monitoring information handling system battery warranties. Information handling systems 10 are manufactured at a manufacture site 12 having a battery warranty database 14. As batteries 16 are built into information handling systems 10, a unique identifier integrated in each battery 16 is read from the battery 16 and stored in battery warranty database 14 along with associated warranty terms. The warranty terms include, for instance, a predetermined number of charging cycles, a warranty period that begins at the first non-manufacturing use of the battery, and a prorata warranty coverage. Once information handling system 10 is assembled and the battery warranty information is recorded, information handling system 10 is shipped to a user site 18, such as in response to a customer order. Battery 16 includes a timer state machine 20 and identification information 22 integrated in firmware. On initial use of information handling system 10 at user site 18, timer state machine 20 initiates to track the battery warranty period. If the battery fails within the warranty period, the user interfaces through a network 26, such as the Internet, to request warranty coverage from a battery warranty site 28. A prorata engine 30 retrieves the time recorded by timer state machine 20 since the initiation of the warranty period and prorates the warranty coverage to the unexpired warranty period in accordance with the warranty terms retrieved from battery warranty database 14. A verification engine 32 verifies the coverage by reference to the unique identifier read from battery identification information 22 compared with identification information of battery warranty database 14. The user returns the battery to the manufacturer where verification engine 32 reads the identification information 22 from the returned battery to verify that the covered battery was returned.

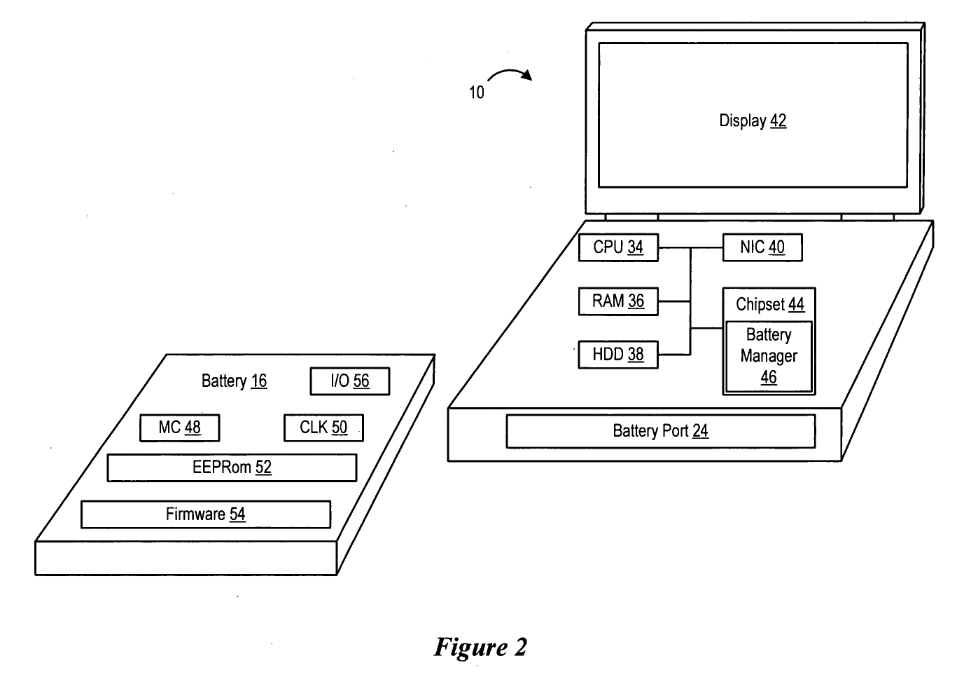

Referring now to FIG. 2, a block diagram depicts an information handling system 10 having battery warranty monitoring. Information handling system 10 has processing components to process information, such as a CPU 34, RAM 36, hard disk drive 38, network interface card 40, display 42 and chipset 44. A battery manager 46 supported by firmware in chipset 44 interfaces with battery 16 to manage battery warranty monitoring. Battery 16 includes a microcontroller 48 that runs at a relatively low speed of 4 or 8 Mhz using low power provided by battery 16 to manage battery operations. Timer state machine 20 is essentially a counter that counts microcontroller clock cycles or, alternatively for greater accuracy, counts an independent clock 50 operating with greater precision such as a 32 Khz crystal. The counter is, for instance, supported by EEPROM 52 and firmware 54, which count time in registers readable by I/O 56 but protected from alteration by a user. Battery manager 46 initiates timer state machine 20 by communication through I/O 56 with microcontroller 48. For instance, battery manager 46 sends a command to initiate timer state machine 20 if information handling system is experiencing a first system start boot that is post-manufacture. Alternatively, if battery 16 is new, battery manager 46 detects that the battery is new and initiates timer state machine 20 on the first interface of battery 16 with information handling system 10. During a warranty inquiry, battery manager 46 retrieves the battery identifier and expired warranty time from EEPROM 52 for communication with warranty site through NIC 40.

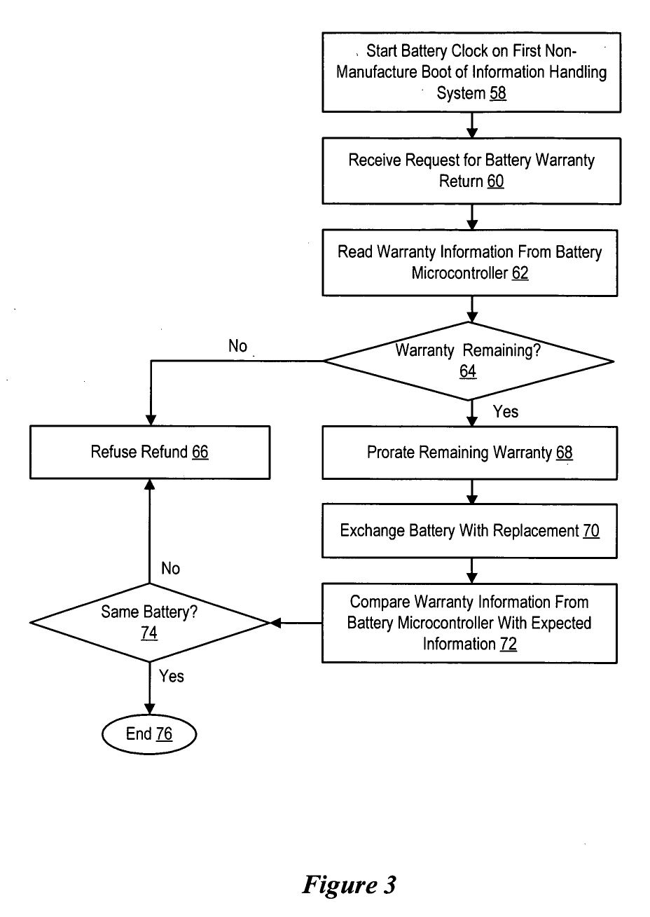

Referring now to FIG. 3, a method for monitoring an information handling system battery warranty. The process begins at step 58 with initiation of the battery clock to track the warranty period on the first non-manufacture boot of the information handling system. At step 60, a request made by a user is received for warranty coverage, such as the return of the battery in exchange for a replacement battery. At step 62, the warranty information, such as the battery identifier and remaining warranty period, is read from the battery microcontroller and communicated to the manufacturer warranty site. At step 64, a determination is made of whether any warranty coverage remains for the battery. If the warranty period has expired, the process continues to step 66 to refuse the warranty refund. If the expired time is less than the warranty period, the process continues to step 68 for a determination of the prorata warranty remaining. For instance, if one-half of the warranty period has expired, the manufacturer pays one-half the cost of the replacement battery. At step 70, the failed battery is shipped to the manufacturer and a replacement battery is shipped to the user. At step 70, the manufacturer reads the expired time and identification information from the returned battery to confirm that the user returned the correct battery. At step 74, if the returned battery is not the battery under warranty then the process continues to step 66 to refuse the warranty refund to the user. If at step 74 the returned battery is the same battery as was under warranty, the process ends at step 76.

Although the present invention has been described in detail, it should be understood that various changes, substitutions and alterations can be made hereto without departing from the spirit and scope of the invention as defined by the appended claims.

1. A system for managing battery warranties for batteries associated with information handling systems, the system comprising:
a clock integrated in each battery and operable to track the time expired from a warranty period of the associated battery;
a battery manager running on each information handling system and operable to read the expired time; and
a battery warranty site operable to interface with the information handling systems through a network, the battery warranty site having a prorata engine operable to retrieve the expired time and determine a warranty coverage for the battery from the expired time.

2. The system of claim 1 further comprising battery identification information integrated in each battery, the battery warranty site further having a verification engine operable to retrieve the battery identification and verify with the battery identification that the battery is covered by the warranty.

3. The system of claim 2 wherein the battery warranty site is further operable to verify that a battery shipped from the information handling system to the warranty site has the battery identification.

4. The system of claim 1 wherein the battery manager is further operable to:
identify a new battery interfaced with the information handling system; and
initiate the clock to count time expired from the warranty for the new battery.

5. The system of claim 1 wherein the battery manager is further operable to:
determine a first non-manufacture boot of the information handling system; and
initiate the clock to count time expired from the warranty upon detection of the first non-manufacture boot.

6. The system of claim 1 wherein the clock comprises the clock of a microprocessor integrated with the battery.

7. A method for managing information handling system battery warranties, the method comprising:
initiating a clock integrated in the battery at the start of a warranty period;
receiving a warranty request to replace the battery;
reading the clock of the battery with the information handling system to determine the remaining warranty period; and
replacing the battery according to the remaining warranty period.

8. The method of claim 7 wherein initiating a clock further comprises:
determining that a new battery is interfaced with an information handling system; and
initiating the clock of the battery with the first interface between the battery and the information handling system.

9. The method of claim 7 wherein initiating a clock further comprises:
determining a first non-manufacture boot of the information handling system; and
initiating the clock of the battery at the first non-manufacture boot.

10. The method of claim 7 further comprising:
associating unique identification with each battery; and
reading the unique identification in response to the warranty request; and
verifying that the read unique identification matches a unique identification of a battery under warranty.

11. The method of claim 10 further comprising:
shipping the battery from a user site to a warranty site; and
reading the unique identification from the battery at the warranty site to verify that the battery matches the warranty.

12. The method of claim 7 wherein replacing the battery further comprises replacing a prorata value of the battery for the remaining warranty period.

13. The method of claim 7 wherein reading the clock further comprises reading the clock through a network by a warranty site interfaced with the information handling system and located distal the information handling system.

14. An information handling system comprising:
processing components operable to process information;
a battery operable to provide power to the processing components; and
a timer state machine running in the battery and operable to track time from a predetermined event.

15. The information handling system of claim 14 wherein the predetermined event comprises the initiation of a warranty period for the battery.

16. The information handling system of claim 15 further comprising a battery manager operable to determine the first non-manufacture boot of an information handling system and to start the warranty period for the battery at the first non-manufacture boot.

17. The information handling system of claim 15 further comprising a battery manager operable to determine the first interface of a battery with the information handling system and to start the warranty period for the battery at the first interface of the battery with the information handling system.

18. The information handling system of claim 16 further comprising a unique identifier stored in the battery and wherein the battery manager is further operable to communicate the time from initiation of the warranty period and the unique identifier through a network to battery warranty site.

19. The information handling system of claim 15 wherein the timer state machine comprises a microprocessor having a clock, the timer counting clock cycles.

20. The information handling system of claim 15 wherein the timer state machine comprises an independent clock.
